(19) United States
(12) Patent Application Publication
(10) Pub. No.: US 2005/0187005 A1
(43) Pub. Date: Aug. 25, 2005

(54) Gaming machine with award reveal feature

(75) Inventor: Bradley A. Rose, Chicago, IL (US)

Correspondence Address: JENKENS & GILCHRIST, P.C., 225 WEST WASHINGTON, SUITE 2600, CHICAGO, IL, 60606, US

(73) Assignee: WMS Gaming Inc.

(21) Appl. No.: 10/786,509

(22) Filed: Feb. 25, 2004

(51) Int. Cl. A63F 13/00

(52) U.S. Cl. 463/20

(57) ABSTRACT

The present invention provides a method and apparatus of revealing previously hidden indicia associated with selectable objects on a separate display image upon completion of a selection game. The selected objects and associated indicia are displayed as an identifiable group and the unselected objects and associated indicia are presented as another identifiable group. The indicia are indicative of an award, an end bonus marker, or a trigger for another game feature.

### FIELD OF THE INVENTION

The present invention relates generally to gaming machines and, more particularly, to a slot machine including an award reveal feature.

### BACKGROUND OF THE INVENTION

Gaming machines, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning each machine is roughly the same (or believed to be the same), players are most likely to be attracted to the most entertaining and exciting of the machines. Shrewd operators consequently strive to employ the most entertaining and exciting machines available because such machines attract frequent play and hence increase profitability to the operator. Accordingly, in the competitive gaming machine industry, there is a continuing need for gaming machine manufacturers to produce new types of games, or enhancements to existing games, which will attract frequent play by increasing the entertainment value and excitement for the player.

One concept originally employed to increase the entertainment value of a reel spinning game is a bonus round, providing the player with a different game experience occurring randomly during play of the basic game. Typically, a predetermined set of symbols on the basic reel game triggers a bonus round. Bonus games take on a variety of themes and in many cases require the player to make choices that typically instill a feeling of control or self-destiny. A concept often found in bonus games today is the selection of animated characters or objects that potentially provide the player with a winning outcome. In many cases, the selection results in immediate feedback to the player of an award, a loss, or the completion of the bonus round.

When bonus rounds are completed, a number of different transition events can occur depending on the game. Sometimes the player is immediately returned to the basic reel slot game and is reliant entirely on the credit meter to determine the amount won during a bonus round. Other games reveal the credits won during the bonus round by superimposing the total over the existing bonus round screen. Many games also have a feature that reveals the credits associated with those objects not selected during the bonus round. These games typically reveal directly over the objects on the screen where play was just completed.

For the convenience of the player and in accordance with the present invention, a separate reveal screen would help show the entire result of the bonus round by segregating and displaying the items selected (with associated award values), the unselected items (with associated award values), and the total of the bonus round award.

### SUMMARY OF THE INVENTION

In one embodiment, a method of conducting a wagering game comprises a plurality of objects of different types, each object associated with hidden indicia, allowing selection of the objects, providing an award for each selected object, thereafter upon completion of the bonus round, displaying the selected objects and associated indicia, and displaying the unselected objects and associated indicia. An apparatus for conducting a wagering game is also disclosed.

### BRIEF DESCRIPTION OF THE DRAWINGS

The foregoing and other advantages of the invention will become apparent upon reading the following detailed description and upon reference to the drawings in which:

FIG. 1 is a perspective view of a gaming machine embodying the present invention;

FIG. 2 is a block diagram of a control mechanism used for communication between interface components, a main processor, and display units;

FIG. 3 is a display image associated with a basic slot game and showing a symbol combination for triggering a bonus game;

FIG. 4 is a display image associated with a bonus game and showing an array of objects;

FIG. 5 is a display image associated with a bonus game and showing a player selection of an object from an array of objects;

FIG. 6 is a display image associated with a bonus game and showing an entertaining presentation of the end of the bonus game; and

FIG. 7 is a display image associated with a bonus game and showing a list of awards associated with individual selected objects, awards associated with unselected objects, and a total of the awards associated with the selected objects.

While the invention is susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents, and alternatives falling within the spirit and scope of the invention as defined by the appended claims.

### DESCRIPTION OF SPECIFIC EMBODIMENTS

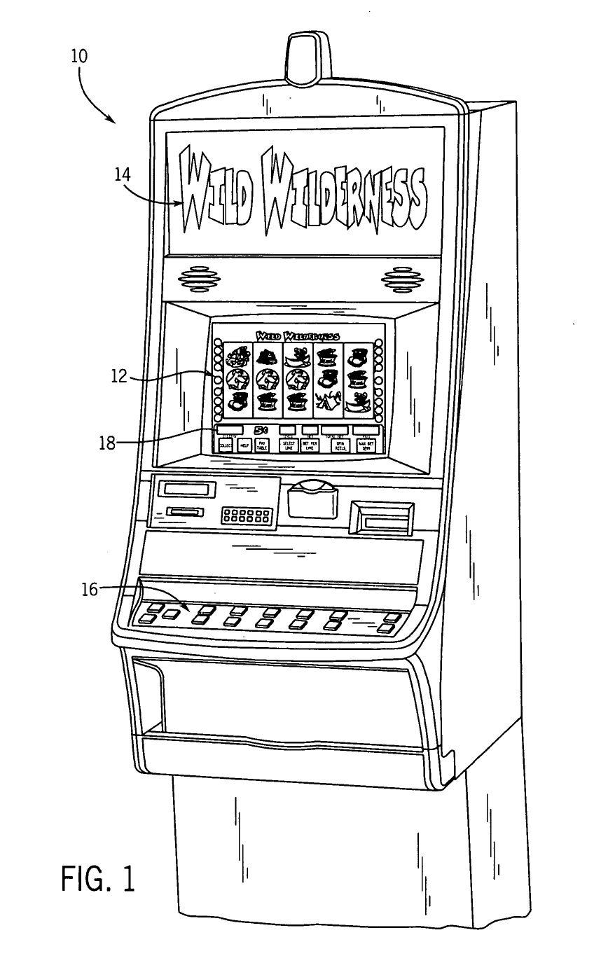

FIG. 1 depicts a gaming machine 10 operable to conduct a video reel slot game. In operation, the gaming machine receives a wager from a player to purchase a “play” of the game. In a “play” of the game, the gaming machine generates at least one random event using a random number generator and provides an award to the player for a winning outcome of the random event. To portray the random event and outcome to the player, the gaming machine includes a video display 12. For a video reel slot game, the video display 12 portrays a plurality of simulated reels that are rotated and stopped to place symbols on the reels in visual association with one or more pay lines.

The video display 12 is preferably in the form of a liquid crystal display (LCD), cathode ray tube (CRT), plasma, or other type of video display known in the art. The display 12 preferably includes a touch screen 18 overlaying the monitor. In the illustrated embodiment, the gaming machine 10 is an “upright” version in which the display 12 is oriented vertically relative to the player. Alternatively, the gaming machine may be a “slant-top” version in which the display 12 is slanted at about a thirty-degree angle toward the player of the gaming machine 10. In addition to the display 12, the gaming machine 10 may include a secondary display 14 for displaying additional game information such as a bonus feature. The game may be operated by a touch screen 18 or by a button panel 16.

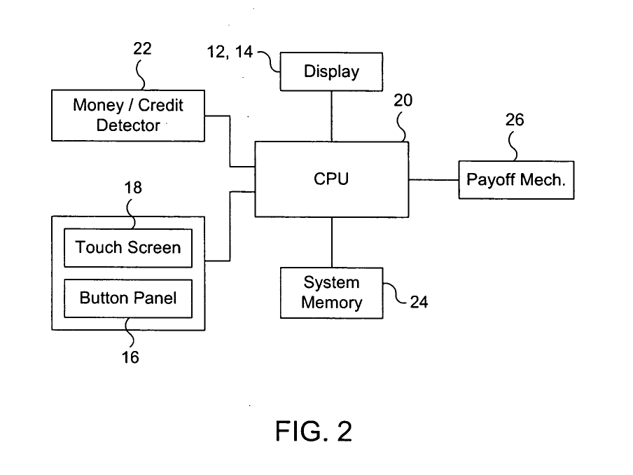

FIG. 2 is a block diagram of a control system suitable for operating the gaming machine. Money/credit detector 22 signals a central processing unit (CPU) 20 when a player has inserted money or played a number of credits. The money may be provided by coins, bills, tickets, coupons, cards, etc. Using the button panel 16 and/or the touch screen 18, the player may select any variables associated with the wagering game and place his/her wager to purchase a play of the game. In a play of the game, the CPU 20 generates at least one random event using a random number generator (RNG) and provides an award to the player for a winning outcome of the random event. Alternatively, the random event may be generated by a remote computer using an RNG or pooling schema and then transmitted to the gaming machine. The CPU 20 operates the display 12 to represent the random event(s) and outcome(s) in a visual form that can be understood by the player. In addition to the CPU 20, the control system may include one or more additional slave control units for operating the display 12.

System memory 24 stores control software, operational instructions, and data associated with the gaming machine. In one embodiment, the system memory 24 comprises a separate read-only memory (ROM) and battery-backed random-access memory (RAM). However, it will be appreciated that the system memory 24 may be implemented on any of several alternative types of memory structures or may be implemented on a single memory structure. A payoff mechanism 26 is operable in response to instructions from the CPU 20 to award a payoff to the player. The payoff may, for example, be in the form of a number of credits. The number of credits is determined by one or more math tables stored in the system memory 24.

Referring back to FIG. 1, to play the reel slot game, a player selects a number of pay lines and places a wager on the selected lines using the button panel 16 and/or the touch screen 18. In response to pressing a “Spin Reels” button, the CPU spins and randomly stops the plurality of simulated reels on the display 12 to place symbols on the reels in visual association with the pay lines. Other mechanisms, such as a handle, may be used to set the reels in motion. The number of reels and pay lines may be varied to be more or less than what is illustrated. The CPU 20 uses the random number generator to select a game outcome (e.g., “basic” game outcome) corresponding to a particular set of reel “stop positions.” The CPU 20 then causes each of the reels to stop at the appropriate stop position. Symbols are displayed on the reels to graphically illustrate the reel stop positions and indicate whether the stop positions of the reels represent a winning game outcome.

Winning basic game outcomes (e.g., symbol combinations resulting in payment of coins or credits) are identifiable to the player by a pay table. The pay table may be affixed to the machine 10 and/or displayed by the display 12 in response to a command by the player (e.g., by pressing a “Pay Table” key). A winning basic game outcome occurs when the symbols appearing on the reels along a pay line correspond to one of the winning combinations on the pay table. A winning combination, for example, could be a number of matching symbols along an active pay line, where the award is greater as the number of matching symbols along the pay line increases. If the displayed symbols stop in a winning combination, the game credits the player an amount corresponding to the award in the pay table for that combination multiplied by the number of credits wagered on the active pay line. The player may collect the amount of accumulated credits by pressing a “Collect” key.

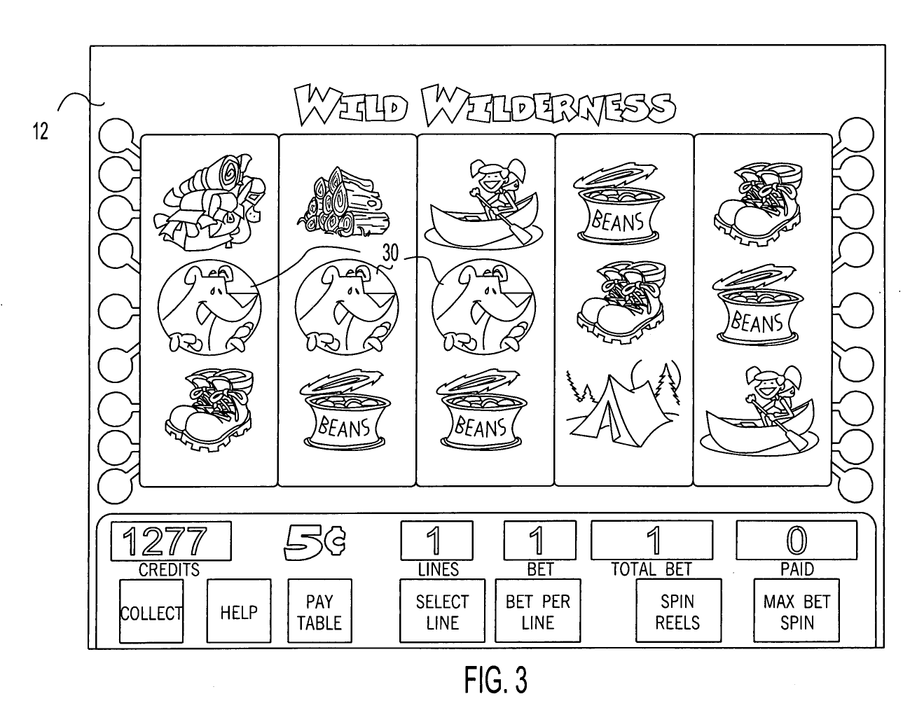

The present invention provides a method of displaying the award results after completing selections in a bonus round. FIG. 3 shows a reel symbol combination from an entertaining video reel slot game called “Wild Wilderness” that triggers a bonus game. In this example, the display 12 reveals bonus symbols 30 in the first, second, and third reels along an active pay line. As will be appreciated by those with ordinary skill in the art, the manner in which the bonus is triggered can be determined by any combination of any number of bonus symbols as defined by the reel slot video game and presented in the pay table or game instructions.

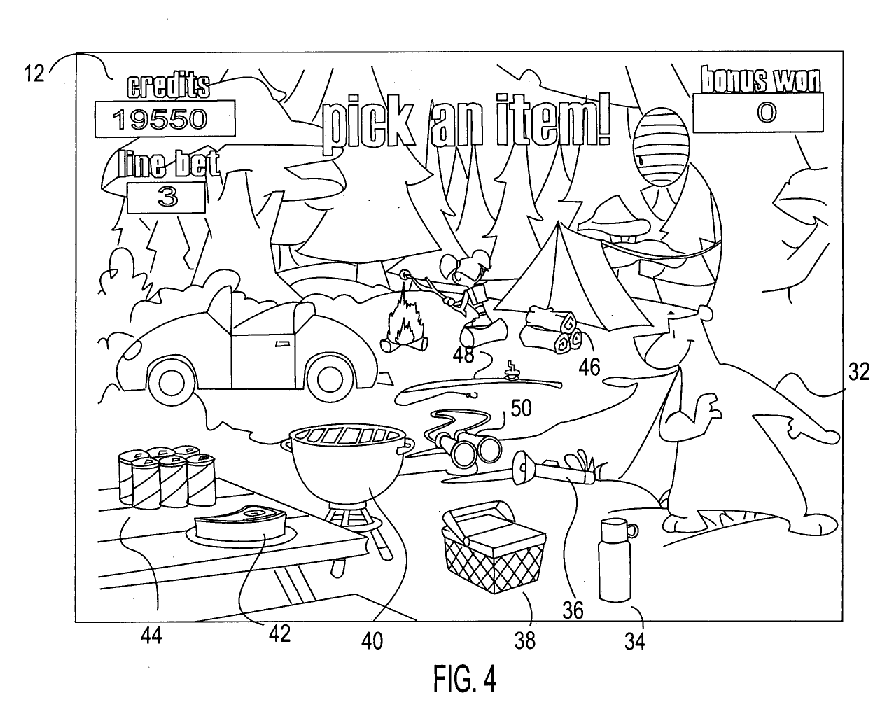

Display 12 in FIG. 4 now directs the player to choose one of the bonus symbols from an entertaining animated campground setting. In this embodiment, the player is to touch the screen immediately over the object of choice to reveal an award. The selectable objects include a drinking container 34, a flashlight 36, a picnic basket 38, a barbeque grill 40, a cut of meat 42, a six pack of soda 44, a stack of firewood 46, a fishing pole 48, or a pair of binoculars 50.

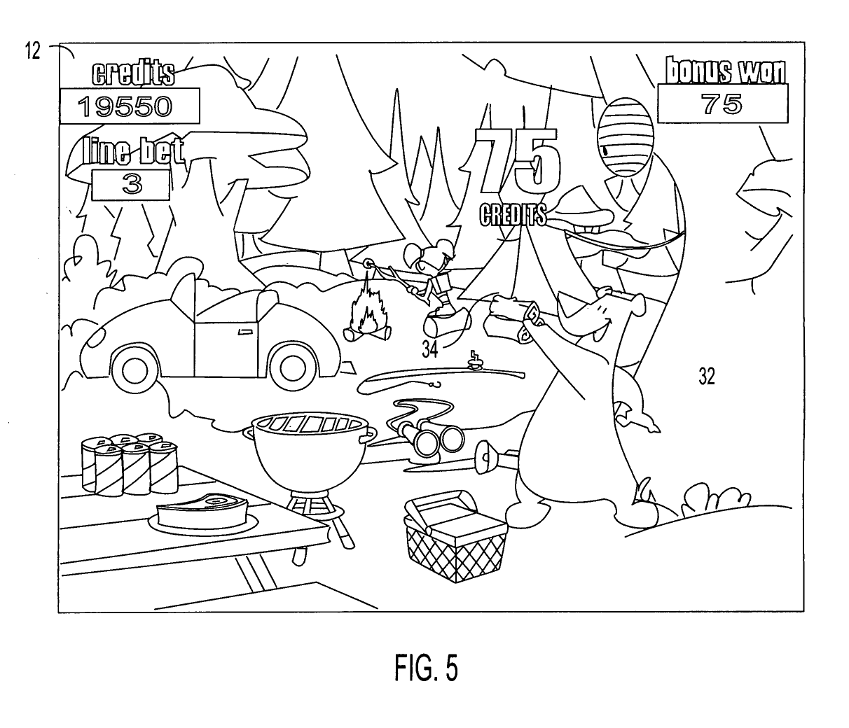

FIG. 5 shows the result of the player's initial choice. An animated bear character 32 responds to the player's input (touching the drinking container 34 object via the screen) and “picks up” the drinking container 34. This combination of events causes the award to be revealed.

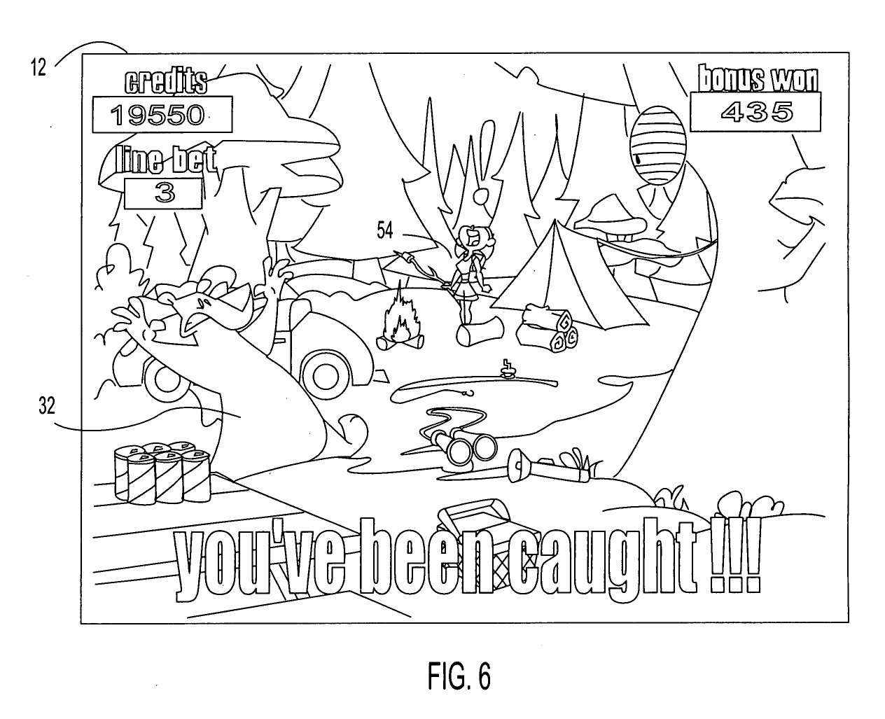

FIG. 6 shows an entertaining end to the bonus round. The player has selected a number of objects. In this embodiment, some of those objects have a hidden “end game” marker. If two of these markers are unknowingly selected, an entertaining representation of the bonus round ending is presented. In this example, the “camper” 54 “catches” the animated bear character 32 and the bonus round ends.

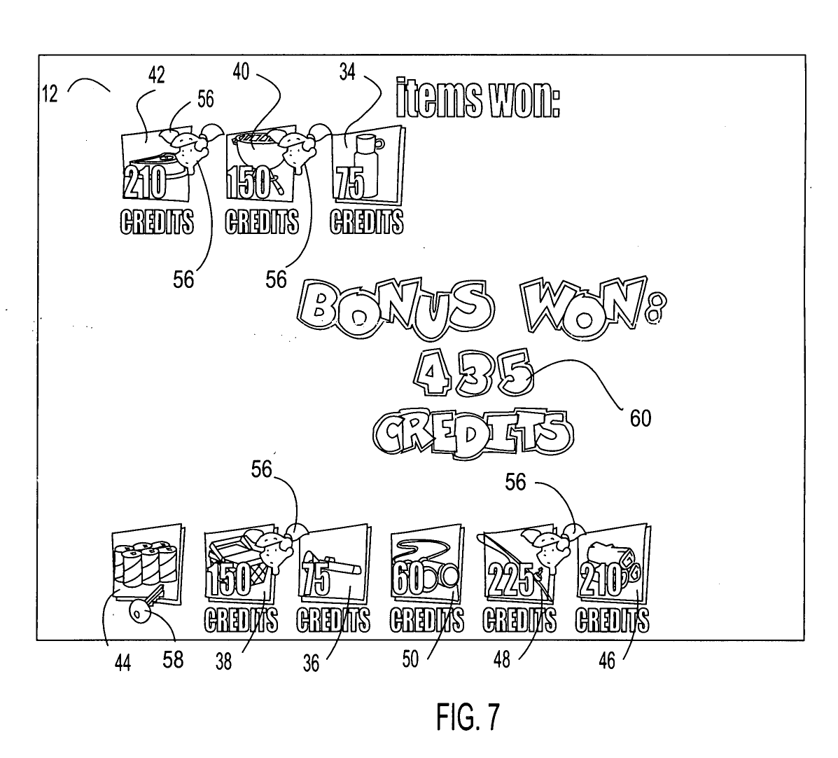

FIG. 7 shows a display image changed to a reveal award screen. In this example, the player has successfully chosen the three objects at the top of the screen. The awards for each object are displayed. The player has chosen the cut of meat 42 with a value of 210 credits, the barbeque grill 40 with a value of 150 credits, and the drinking container 34 with a value of 75 credits. Associated with the cut of meat 42 and the barbeque grill 40 is a representation of the camper 56. In this example, the selection of the two objects with the unseen inclusion of the camper 56 serves as an end game trigger. At the bottom of the screen, the objects that the player did not select are displayed along with the credit values that could have been won had these objects been selected. Note the end game marker (the camper 56) on the picnic basket 38 and the fishing pole 48. Also displayed among these unselected objects is a key 58 associated with the six-pack of soda 44. Had the player selected this object, the next bonus round would have been presented. The final information displayed on this screen is a total for the bonus won 60. This number is a sum of the credit values for all the selected objects displayed at the top of the screen.

While the present invention has been described with reference to one or more particular embodiments, those skilled in the art will recognize that many changes may be made thereto without departing from the spirit and scope of the present invention.

For example, if the bonus round occurs on a mechanical reel slot game, the bonus round can be presented on a second display image and, in turn, the bonus award reveal feature can also be presented on the second display image.

Another variation is the step of revealing the award or other previously hidden information on a pop-up window, appearing superimposed over the bonus round presentation.

Each of these embodiments and obvious variations thereof is contemplated as falling within the spirit and scope of the claimed invention, which is set forth in the following claims.

1. A method of conducting a wagering game, comprising:
displaying a plurality of selectable objects on a first display image;
selecting one or more of the selectable objects;
revealing one or more indicia associated with the selected objects; and
revealing, on a second display image, one or more indicia associated with the unselected objects.

2. The method of claim 1, wherein the step of displaying the plurality of selectable objects occurs in a bonus game.

3. The method of claim 1, wherein the step of displaying the plurality of selectable objects occurs in a basic game.

4. The method of claim 1, wherein said indicia is indicative of an award, an end bonus marker, or a trigger for another game feature.

5. The method of claim 1, wherein the step of revealing the one or more indicia includes revealing the indicia in proximity to the respective selected objects.

6. The method of claim 1, wherein the second display image presents the indicia associated with the selected objects and the indicia associated with the unselected objects.

7. The method of claim 6, wherein the second display image presents a total award based on the indicia associated with the selected objects.

8. The method of claim 6, wherein the second display image presents the selected objects with associated indicia as a group.

9. The method of claim 6, wherein the second display image presents the unselected objects with associated indicia as a group.

10. The method of claim 1, wherein the first display image and the second display image are presented on a common display.

11. The method of claim 1, wherein the first display image and the second display image are presented on different displays.

12. An apparatus for conducting a wagering game, comprising:
a value input device for receiving a wager from a player;
a display for presenting a plurality of selectable objects on a first display image; and
a controller operative to
select one or more of the selectable objects;
reveal one or more indicia associated with the selected objects; and
reveal, on a second display image, one or more indicia associated with the unselected objects.

13. The apparatus of claim 12, wherein the display is operative to present the plurality of selectable objects during a bonus game.

14. The apparatus of claim 12, wherein the display is operative to present the plurality of selectable objects during a basic game.

15. The apparatus of claim 12, wherein the controller is operative to reveal the indicia in proximity to the respective selected objects.

16. The apparatus of claim 12, wherein the second display image presents the indicia associated with the selected objects and the indicia associated with the unselected objects.

17. The apparatus of claim 16, wherein the second display image presents a total award based on the awards associated with the selected objects.

18. The apparatus of claim 16, wherein the second display image presents the selected objects with associated indicia in an identifiable group.

19. The apparatus of claim 16, wherein the second display image presents the unselected objects with associated indicia in an identifiable group.

20. The apparatus of claim 12, wherein the second display image is presented on the display.

21. The apparatus of claim 12, wherein the second display image is presented on a second display.

22. A medium encoded with a program for implementing a method, said program for directing a device to perform the steps of:
displaying a plurality of selectable objects on a first display image;
selecting one or more of the selectable objects;
revealing one or more indicia associated with the selected objects; and
revealing, on a second display image, one or more indicia associated with the unselected objects.
